(19) United States
(12) Patent Application Publication
(10) Pub. No.: US 2013/0329010 A1
(43) Pub. Date: Dec. 12, 2013

(54) THREE-DIMENSIONAL (3-D) IMAGE REVIEW IN TWO-DIMENSIONAL (2-D) DISPLAY

(71) Applicant: Samsung Electronics Co., Ltd., Suwon (KR)

(72) Inventors: Byoungju Kim, Walnut Creek, CA (US); Prashant Desai, San Francisco, CA (US)

(73) Assignee: Samsung Electronics Co., Ltd

(21) Appl. No.: 13/912,099

(22) Filed: Jun. 6, 2013

Related U.S. Application Data
(60) Provisional application No. 61/781,684, filed on Mar. 14, 2013.
(60) Provisional application No. 61/657,537, filed on Jun. 8, 2012.

(51) Int. Cl. H04N 13/02

(52) U.S. Cl. CPC H04N 13/0207
USPC 348/43

(57) ABSTRACT

A method of providing three-dimensional (3-D) image effects comprises capturing, using the electronic device, three or more two-dimensional (2-D) image layers for an image, stacking the three or more 2-D image layers to create a 3-D effect for the image, activating the 3-D image effect for displaying the image in 3-D, and displaying the image with a 3-D effect.

### CROSS-REFERENCE TO RELATED APPLICATIONS

This application claims the priority benefit of U.S. Provisional Patent Application Ser. No. 61/657,537, filed Jun. 8, 2012, and U.S. Provisional Patent Application Ser. No. 61/781,684, filed Mar. 14, 2013, both incorporated herein by reference in their entirety.

### TECHNICAL FIELD

One or more embodiments relate generally to three-dimensional (3-D) images and, in particular, to viewing 3-D images in a two-dimensional (2-D) display on an electronic device.

### BACKGROUND

With the proliferation of electronic devices, such as mobile electronic devices, users are using the electronic devices for taking photos and photo editing. Photos taken on mobile electronic devices, such as cell-phones, are two-dimensional (2-D) photographs that are displayed on a 2-D display.

### SUMMARY

An embodiment relates generally to providing three-dimensional (3-D) image effects with an electronic device.

In one embodiment, a method of providing three-dimensional (3-D) image effects comprises capturing, using an electronic device, three or more two-dimensional (2-D) image layers for an image with the electronic device, stacking the three or more 2-D image layers to create a 3-D effect for the image, activating the 3-D image effect for displaying the image in 3-D, and displaying the image with a 3-D effect.

In another embodiment, an electronic device comprises a display and an image processing module. In one embodiment, the image processing module configured to stack three or more two-dimensional (2-D) image layers captured with an image capture device for providing a three-dimensional imaging effect on the display. The three or more 2-D image layers each comprise different imaging settings.

One embodiment comprises a non-transitory computer-readable medium having instructions which when executed on a computer perform a method comprising: capturing three or more two-dimensional (2-D) image layers for an image with the electronic device. The three or more 2-D image layers are stacked to create a 3-D effect for the image. The 3-D image effect for displaying the image in 3-D is activated. The image is displayed with a 3-D effect.

These and other aspects and advantages of one or more embodiments will become apparent from the following detailed description, which, when taken in conjunction with the drawings, illustrate by way of example the principles of one or more embodiments.

### BRIEF DESCRIPTION OF THE DRAWINGS

For a fuller understanding of the nature and advantages of one or more embodiments, as well as a preferred mode of use, reference should be made to the following detailed description read in conjunction with the accompanying drawings, in which:

FIGS. 1A-1B show block diagrams of architecture on a system for providing 3-D image effects with an electronic device, according to one or more embodiments.

FIG. 2 shows an example of stacked images, according to one or more embodiments.

FIGS. 3A-B show examples of changing viewpoints of a 3-D image effect, according to one or more embodiments.

FIG. 4 shows a flowchart of a process for providing 3-D image effects, according to one or more embodiments.

FIG. 5 is a high-level block diagram showing an information processing system comprising a computing system implementing one or more embodiments.

FIG. 6 shows a computing environment for implementing an embodiment.

FIG. 7 shows a computing environment for implementing an embodiment.

FIG. 8 shows a computing environment for viewing 3-D images in a two-dimensional (2-D) display, according to an embodiment.

FIG. 9 shows a block diagram of an architecture for a local endpoint host, according to an example embodiment.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One or more embodiments relate generally to using an electronic device for providing 3-D image effects with an electronic device. In this embodiment, multiple view selections for 3-D image effects are provided.

In one embodiment, the electronic device comprises a mobile electronic device capable of data communication over a communication link such as a wireless communication link. Examples of such mobile device include a mobile phone device, a mobile tablet device, smart mobile devices, etc.

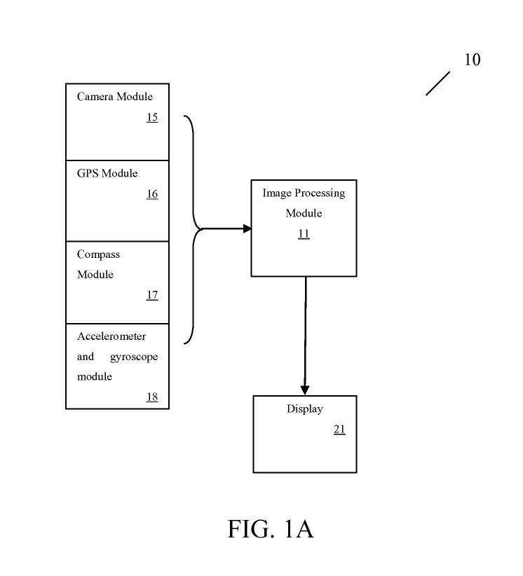

FIG. 1A shows a functional block diagram of an embodiment of a 3-D image effect system 10 for providing 3-D image effects with an electronic device (such as mobile device 20 as shown in FIG. 1B), according to an embodiment.

The system 10 comprises an image processing module 11 including an image selection module 12 (FIG. 1B), a 3-D selection module 13 (FIG. 1B), a layer application module 14 (FIG. 1B) and a point-of-view (POV) module 22 (FIG. 1B). The image processing module 11 utilizes mobile device hardware functionality including one or more of: an image capture device such as, e.g., camera module 15, global positioning satellite (GPS) receiver module 16, compass module 17, and accelerometer and gyroscope module 18.

The camera module 15 is used to capture images of objects, such as people, surroundings, places, etc. The GPS module 16 is used to identify a current location of the mobile device 20 (i.e., user). The compass module 17 is used to identify direction of the mobile device. The accelerometer and gyroscope module 18 is used to identify tilt of the mobile device.

The system 10 provides creating photos using multiple depth-of-field (DOF) images that are layered for providing 3-D effects for 2-D photo images, and selection of different points of view for displaying 3-D image effects on the mobile device display 21. The system 10 provides a simple, fluid, and responsive user experience.

The creation of 3-D photo imaging effects from multiple 2-D images having different DOFs comprises integrating information including camera data, DOF data, and optionally, location data, sensor data (i.e., magnetic field, accelerometer, rotation vector), etc. For example, Google Android mobile operating system application programming interface (API) components providing such information may be employed.

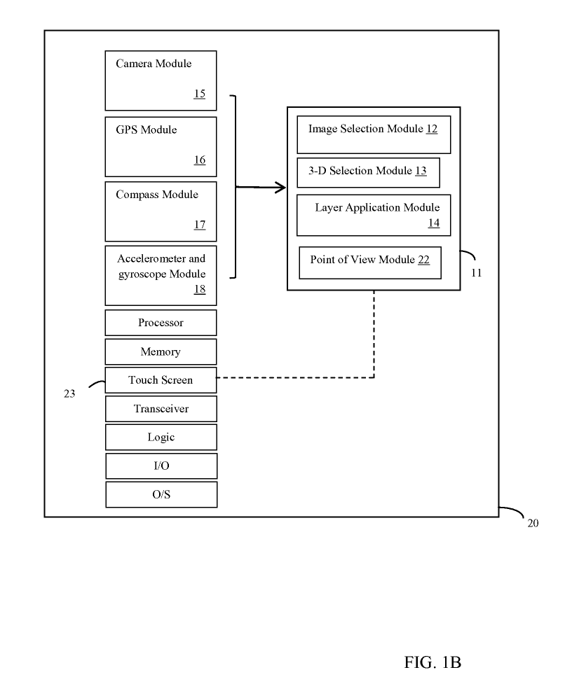

As illustrated in FIG. 2, in one embodiment, when it is desired to display a 3-D effect for taking a photo, the 3-D selection module 13 senses the selection and configures the camera module for taking multiple photos with different DOFs. For example, a first photo with a first DOF is used as a background large DOF 210, a second photo with a second DOF is used as a mid-ground medium DOF 220, and a third photo with a third DOF is used as a foreground subject small DOF 230. In one embodiment, the different DOFs may be associated with different parameters/settings, such as f-numbers (i.e., f-stops) and degree of focus. For example, a first layer may have a high f-number associated with a large DOF and deep focus, a second layer may have a mid-f-number associated with a medium DOF and medium focus, and a third layer may have a low f-number associated with a small DOF and shallow focus, etc.

In one embodiment, the layer application module 14 stacks or layers the different photos next to one another (e.g., on top of each other, behind one another, etc.) with different DOFs to result in a 3-D photo image 240. The point-of-view module 22 is used for providing different views or angles (e.g., a left-side angled POV or a right-side angled POV) of observation as desired using the touch screen 23 of the electronic device 20.

In one embodiment, a user aims a camera of a mobile device (e.g., smartphone, tablet, smart device) including the image processing module 11 towards a target object/subject, for example an object, scene, or person(s) at a physical location, such as a city center, attraction, event, etc. that the user is visiting and takes a photo. The photo from the camera application (e.g., camera module 15) is processed by the mobile device 20 and displayed on a display monitor 21 of the mobile device 20.

In one embodiment, the mobile image processing module 11 includes an image selection module 12 (FIG. 1B) that provides a selection function for selecting a photo image (e.g., photo image 240) for sharing (e.g., emailing, text messaging, uploading/pushing to a network, etc.).

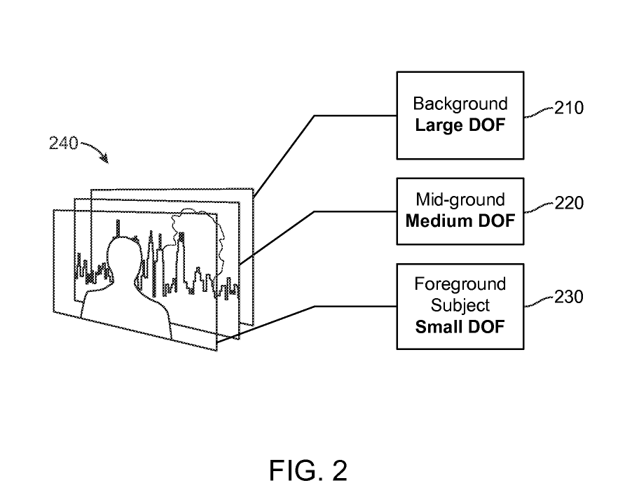

Referring to FIGS. 3A-B, in one embodiment, once activated, the image processing module 11 enables the user to capture a photo image where three or more image layers with three or more different DOFs are captured simultaneously. In one embodiment, after the photo is captured, the layer application module performs digital image processing on the three or more layers such that the different layers are overlaid, either directly on top of or behind one another, or separated by a distance from one another to provide a 3-D image effect.

Using the touch screen 23, a photo image is selected for 3-D effects review, for example, by making a long press on top of an image displayed on the display 21, the image is selected for 3-D effects review using the 3-D selection module 13. Once an image is selected for 3-D effects review, a swipe to the left 310 or to the right 320 on the image displayed on the display 21 provides for different angled views to be shown on the display 21 (e.g., left-angled view 330 or right-angled view 340). The different selected POVs appear to a user as though they are looking at the image from slightly different angles with the foreground depths feeling detached from the background depths. The POV selection provides for the user to change their viewing perspective without physically having to change their viewing perspective to enjoy the 3-D effect. The 3-D effect using the layering application module 14 provides a 3-D glasses-free effect and provides user control by enabling intuitive, gestural interaction with the displayed image.

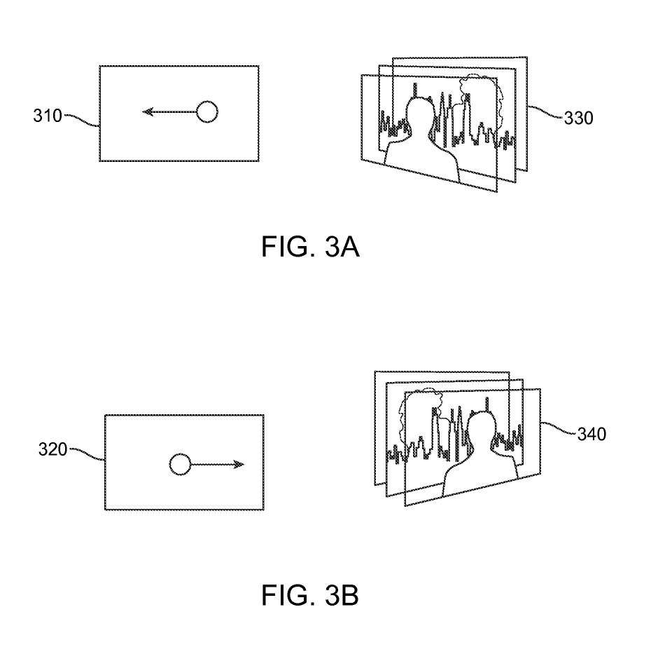

FIG. 4 shows a flowchart of a 3-D image photo effect process 400, according to one or more embodiments. Process block 410 comprises using an electronic device to capture a photo image. Process block 420 comprises storing multiple layers of images having different parameters (e.g., different DOFs) based on the captured photo. Process block 430 comprises stacking the multiple layers of images. Process block 440 comprises selecting 3-D image effects. Process block 450 comprises selecting a POV for the 3-D image to be displayed on the electronic device.

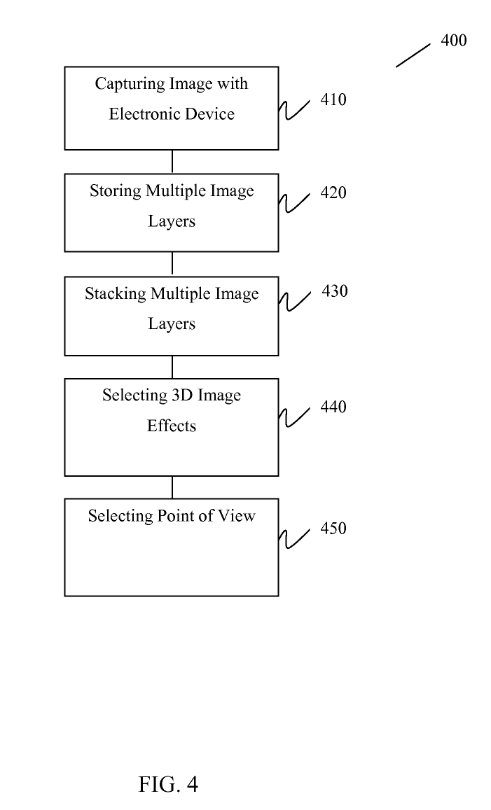

FIG. 5 is a high-level block diagram showing an information processing system comprising a computing system 500 implementing an embodiment. The system 500 includes one or more processors 511 (e.g., ASIC, CPU, etc.), and can further include an electronic display device 512 (for displaying graphics, text, and other data), a main memory 513 (e.g., random access memory (RAM)), storage device 514 (e.g., hard disk drive), removable storage device 515 (e.g., removable storage drive, removable memory module, a magnetic tape drive, optical disk drive, computer-readable medium having stored therein computer software and/or data), user interface device 516 (e.g., keyboard, touch screen, keypad, pointing device), and a communication interface 517 (e.g., modem, wireless transceiver (such as WiFi, Cellular), a network interface (such as an Ethernet card), a communications port, or a PCMCIA slot and card). The communication interface 517 allows software and data to be transferred between the computer system and external devices. The system 500 further includes a communications infrastructure 518 (e.g., a communications bus, cross-over bar, or network) to which the aforementioned devices/modules 511 through 517 are connected.

The information transferred via communications interface 517 may be in the form of signals such as electronic, electromagnetic, optical, or other signals capable of being received by communications interface 517, via a communication link that carries signals and may be implemented using wire or cable, fiber optics, a phone line, a cellular phone link, an radio frequency (RF) link, and/or other communication channels.

In one implementation of an embodiment in a mobile wireless device such as a mobile phone, the system 500 further includes an image capture device such as a camera 15. The system 500 may further include application modules as MMS module 521, SMS module 522, email module 523, social network interface (SNI) module 524, audio/video (AV) player 525, web browser 526, image capture module 527, etc.

The system 500 further includes an image processing module 11 as described herein, according to an embodiment. In one implementation of said image processing module 11 along an operating system 529 may be implemented as executable code residing in a memory of the system 500. In another embodiment, such modules are in firmware, etc.

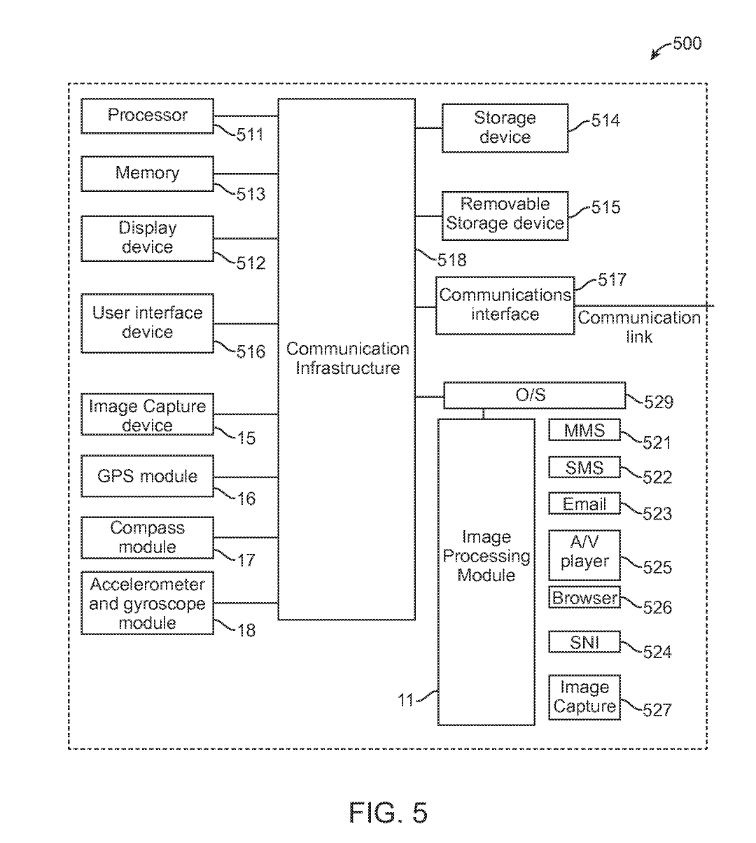

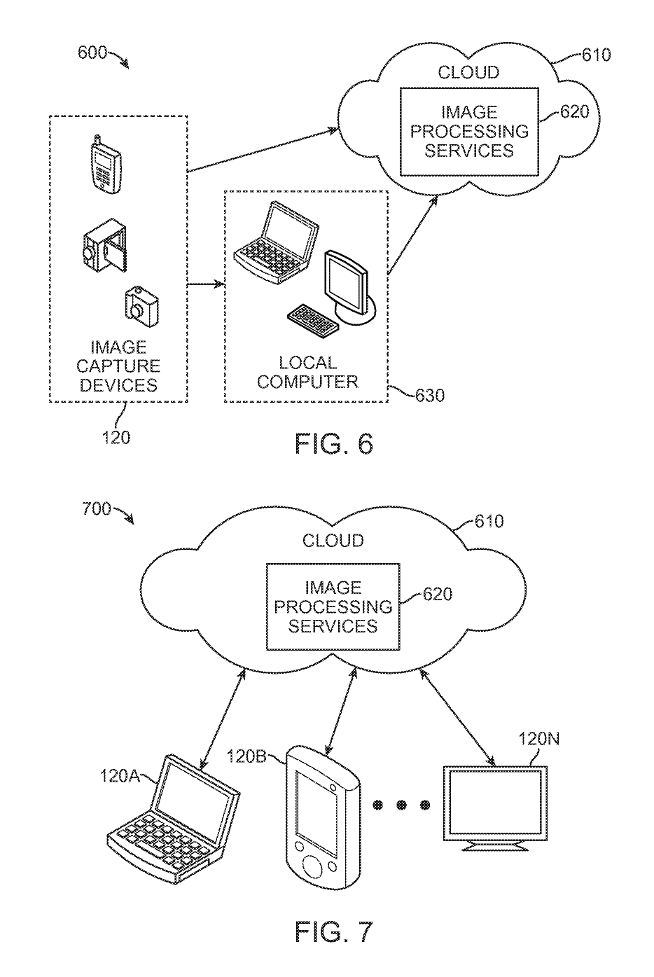

FIGS. 6 and 7 illustrate examples of networking environments 600 and 700 for cloud computing in which image processing for 3-D image effect embodiments described herein may utilize. In one embodiment, in the environment 600, the cloud 610 provides services 620 (such as media and comment sharing, social networking services, among other examples) for user computing devices, such as electronic device 120. In one embodiment, services may be provided in the cloud 610 through cloud computing service providers, or through other providers of online services. In one example embodiment, the cloud-based services 620 may include media processing and sharing services that uses any of the techniques disclosed, a media storage service, a social networking site, or other services via which media (e.g., from user sources) are stored and distributed to connected devices.

In one embodiment, various electronic devices 120 include image or video capture devices to capture one or more images or video, create or share comments, etc. In one embodiment, the electronic devices 120 may upload one or more digital images to the service 620 on the cloud 610 either directly (e.g., using a data transmission service of a telecommunications network) or by first transferring the one or more images to a local computer 630, such as a personal computer, mobile device, wearable device, or other network computing device.

In one embodiment, as shown in environment 700 in FIG. 6, cloud 610 may also be used to provide services that include image processing for 3-D image effect embodiments to connected electronic devices 120A-120N that have a variety of screen display sizes. In one embodiment, electronic device 120A represents a device with a mid-size display screen, such as what may be available on a personal computer, a laptop, or other like network-connected device. In one embodiment, electronic device 120B represents a device with a display screen configured to be highly portable (e.g., a small size screen). In one example embodiment, electronic device 120B may be a smartphone, PDA, tablet computer, portable entertainment system, media player, wearable device, or the like. In one embodiment, electronic device 120N represents a connected device with a large viewing screen. In one example embodiment, electronic device 120N may be a television screen (e.g., a smart television) or another device that provides image output to a television or an image projector (e.g., a set-top box or gaming console), or other devices with like image display output. In one embodiment, the electronic devices 120A-120N may further include image capturing hardware. In one example embodiment, the electronic device 120B may be a mobile device with one or more image sensors, and the electronic device 120N may be a television coupled to an entertainment console having an accessory that includes one or more image sensors.

In one or more embodiments, in the cloud-computing network environments 600 and 700, any of the embodiments may be implemented at least in part by cloud 610. In one embodiment example, image processing for 3-D image effect techniques are implemented in software on the local computer 630, one of the electronic devices 120, and/or electronic devices 120A-N. In another example embodiment, the image processing for 3-D image effect techniques are implemented in the cloud and applied to comments and media as they are uploaded to and stored in the cloud. In this scenario, the image processing for 3-D image effect embodiments may be performed using media stored in the cloud as well.

In one or more embodiments, media is shared across one or more social platforms from an electronic device 120. Typically, the shared media is only available to a user if the friend or family member shares it with the user by manually sending the media (e.g., via a multimedia messaging service (“MMS”)) or granting permission to access from a social network platform. Once the media is created and viewed, people typically enjoy sharing them with their friends and family, and sometimes the entire world. Viewers of the media will often want to add metadata or their own thoughts and feelings about the media using paradigms like comments, “likes,” and tags of people. Traditionally, this type of supplemental social data is made via separate social media platforms or applications (e.g., apps).

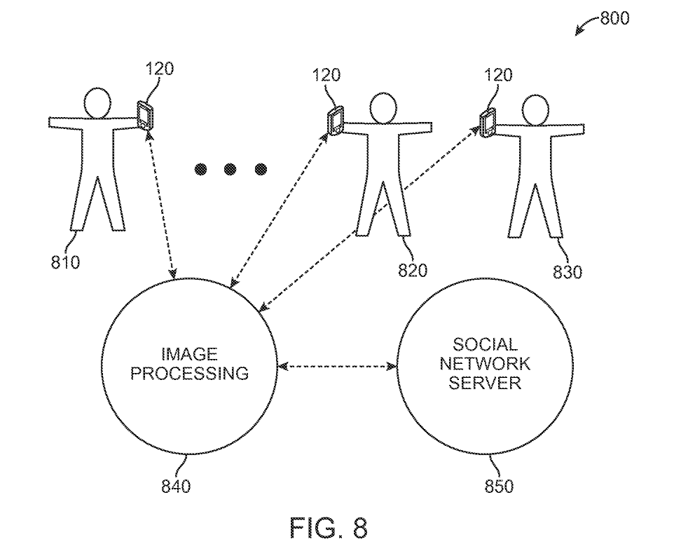

FIG. 8 is a block diagram 800 illustrating example users of an image processing for 3-D image effect system according to an embodiment. In one embodiment, users 810, 820, 830 are shown, each having a respective electronic device 120 that is capable of capturing digital media (e.g., images, video, audio, or other such media) and providing image processing for 3-D image effects. In one embodiment, the electronic devices 120 are configured to communicate with an image processing controller 840, which may be a remotely-located server, but may also be a controller implemented locally by one of the electronic devices 120. In one embodiment where the image processing controller 840 is a remotely-located server, the server may be accessed using the wireless modem, communication network associated with the electronic device 120, etc. In one embodiment, the image processing controller 840 is configured for two-way communication with the electronic devices 120. In one embodiment, the image processing controller 820 is configured to communicate with and access data from one or more social network servers 850 (e.g., over a public network, such as the Internet).

In one embodiment, the social network servers 850 may be servers operated by any of a wide variety of social network providers (e.g., Facebook®, Instagram®, Flickr®, and the like) and generally comprise servers that store information about users that are connected to one another by one or more interdependencies (e.g., friends, business relationship, family, and the like). Although some of the user information stored by a social network server is private, some portion of user information is typically public information (e.g., a basic profile of the user that includes a user's name, picture, and general information). Additionally, in some instances, a user's private information may be accessed by using the user's login and password information. The information available from a user's social network account may be expansive and may include one or more lists of friends, current location information (e.g., whether the user has “checked in” to a particular locale), additional images of the user or the user's friends. Further, the available information may include additional information (e.g., metatags in user photos indicating the identity of people in the photo or geographical data. Depending on the privacy setting established by the user, at least some of this information may be available publicly. In one embodiment, a user that desires to allow access to his or her social network account for purposes of aiding the image processing controller 840 may provide login and password information through an appropriate settings screen. In one embodiment, this information may then be stored by the image processing controller 840. In one embodiment, a user's private or public social network information may be searched and accessed by communicating with the social network server 850, using an application programming interface (“API”) provided by the social network operator.

In one embodiment, the image processing controller 840 performs operations associated with a media sharing application or method. In one example embodiment, the image processing controller 840 may receive media from a plurality of users (or just from the local user), determine relationships between two or more of the users (e.g., according to user-selected criteria), and transmit comments and/or media to one or more users based on the determined relationships.

In one embodiment, the image processing controller 840 need not be implemented by a remote server, as any one or more of the operations performed by the image processing controller 840 may be performed locally by any of the electronic devices 120, or in another distributed computing environment (e.g., a cloud computing environment). In one embodiment, the sharing of media may be performed locally at the electronic device 120.

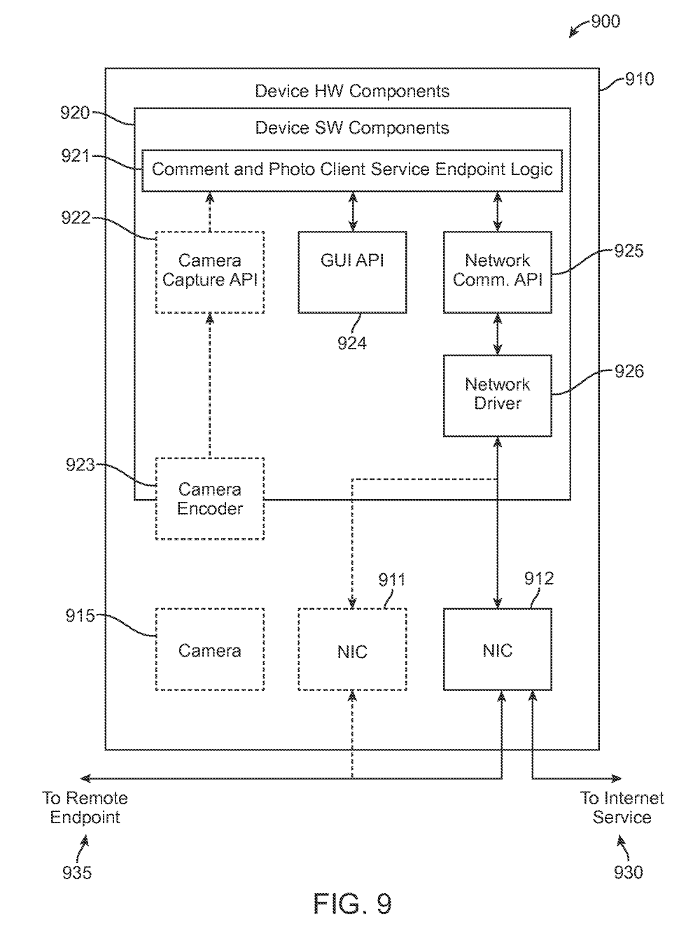

FIG. 9 shows an architecture for a local endpoint host 900, according to an embodiment. In one embodiment, the local endpoint host 900 comprises a hardware (HW) portion 910 and a software (SW) portion 920. In one embodiment, the HW portion 910 comprises the camera 915, network interface (NIC) 911 (optional) and NIC 912 and a portion of the camera encoder 923 (optional). In one embodiment, the SW portion 920 comprises comment and photo client service endpoint logic 921, camera capture API 922 (optional), a graphical user interface (GUI) API 924, network communication API 925, and network driver 926. In one embodiment, the content flow (e.g., text, graphics, photo, video and/or audio content, and/or reference content (e.g., a link)) flows to the remote endpoint in the direction of the flow 935, and communication of external links, graphic, photo, text, video and/or audio sources, etc. flow to a network service (e.g., Internet service) in the direction of flow 930.

One or more embodiments, use features of WebRTC for acquiring and communicating streaming data. In one embodiment, the use of WebRTC implements one or more of the following APIs: MediaStream (e.g., to get access to data streams, such as from the user's camera and microphone), RTCPeerConnection (e.g., audio or video calling, with facilities for encryption and bandwidth management), RTCDataChannel (e.g., for peer-to-peer communication of generic data), etc.

In one embodiment, the MediaStream API represents synchronized streams of media. For example, a stream taken from camera and microphone input may have synchronized video and audio tracks. One or more embodiments may implement an RTCPeerConnection API to communicate streaming data between browsers (e.g., peers), but also use signaling (e.g., messaging protocol, such as SIP or XMPP, and any appropriate duplex (two-way) communication channel) to coordinate communication and to send control messages. In one embodiment, signaling is used to exchange three types of information: session control messages (e.g., to initialize or close communication and report errors), network configuration (e.g., a computer's IP address and port information), and media capabilities (e.g., what codecs and resolutions may be handled by the browser and the browser it wants to communicate with).

In one embodiment, the RTCPeerConnection API is the WebRTC component that handles stable and efficient communication of streaming data between peers. In one embodiment, an implementation establishes a channel for communication using an API, such as by the following processes: client A generates a unique ID, Client A requests a Channel token from the App Engine app, passing its ID, App Engine app requests a channel and a token for the client's ID from the Channel API, App sends the token to Client A, Client A opens a socket and listens on the channel set up on the server. In one embodiment, an implementation sends a message by the following processes: Client B makes a POST request to the App Engine app with an update, the App Engine app passes a request to the channel, the channel carries a message to Client A, and Client A's onmessage callback is called.

In one embodiment, WebRTC may be implemented for a one-to-one communication, or with multiple peers each communicating with each other directly, peer-to-peer, or via a centralized server. In one embodiment, Gateway servers may enable a WebRTC app running on a browser to interact with electronic devices.

In one embodiment, the RTCDataChannel API is implemented to enable peer-to-peer exchange of arbitrary data, with low latency and high throughput. In one or more embodiments, WebRTC may be used for leveraging of RTCPeerConnection API session setup, multiple simultaneous channels, with prioritization, reliable and unreliable delivery semantics, built-in security (DTLS), and congestion control, and ability to use with or without audio or video.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said Architecture can take the form of an entirely hardware embodiment, an entirely software embodiment or an embodiment containing both hardware and software elements.

One or more embodiments have been described with reference to flowchart illustrations and/or block diagrams of methods, apparatus (systems) and computer program products according to one or more embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing one or more embodiments. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of one or more embodiments as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of one or more embodiments.

Though the embodiments have been described with reference to certain versions thereof; however, other versions are possible. Therefore, the spirit and scope of the appended claims should not be limited to the description of the preferred versions contained herein.

What is claimed is:

1. A method of providing three-dimensional (3-D) image effects, comprising:
capturing, using an electronic device, three or more two-dimensional (2-D) image layers for an image;
stacking the three or more 2-D image layers to create a 3-D effect for the image;
activating the 3-D image effect for displaying the image in 3-D; and
displaying the image with a 3-D effect.

2. The method of claim 1, wherein the three or more 2-D image layers comprise different imaging settings.

3. The method of claim 2, wherein the different imaging settings comprise different depth of field (DOF) settings.

4. The method of claim 3, wherein the different imaging settings further comprise different focus and f-number settings.

5. The method of claim 2, further comprising: selecting a point of view for displaying the image in 3-D.

6. The method of claim 5, wherein multiple points of view are selectable for the 3-D image display.

7. The method of claim 4, wherein the three or more 2-D image layers are simultaneously displayed.

8. The method of claim 7, wherein capturing three or more 2-D image layers comprises capturing multiple 2-D images using a single image capturing input.

9. The method of claim 1, wherein the electronic device comprises a mobile electronic device.

10. The method of claim 9, wherein the mobile electronic device comprises one of a mobile phone, a tablet device, and a mobile computing device.

11. An electronic device, comprising:
a display; and
an image processing module configured to stack three or more two-dimensional (2-D) image layers captured with an image capture device for providing a three-dimensional imaging effect on the display, wherein the three or more 2-D image layers each comprises different imaging settings.

12. The electronic device of claim 11, wherein the different imaging settings comprise different depth-of-field (DOF) settings.

13. The electronic device of claim 12, wherein the different imaging settings further comprise different focus and f-number settings.

14. The electronic device of claim 13, wherein the imaging processing module further provides for selections of different points of view for displaying the 3-D image on the display.

15. The electronic device of claim 14, wherein the three or more 2-D image layers are simultaneously displayed on the display.

16. The electronic device of claim 11, wherein the electronic device comprises a mobile electronic device.

17. A non-transitory computer-readable medium having instructions which when executed on a computer perform a method comprising:
capturing three or more two-dimensional (2-D) image layers for an image with an electronic device;
stacking the three or more 2-D image layers to create a 3-D effect for the image;
activating the 3-D image effect for displaying the image in 3-D; and
displaying the image with a 3-D effect.

18. The medium of claim 17, wherein the three or more 2-D image layers comprise different imaging settings.

19. The medium of claim 18, wherein the different imaging settings comprise different depth-of-field (DOF) settings.

20. The medium of claim 19, wherein the different imaging settings further comprise different focus and f-number settings.

21. The medium of claim 20, further comprising: selecting a point of view for displaying the image in 3-D.

22. The medium of claim 21, wherein the three or more 2-D image layers are simultaneously displayed.

23. The medium of claim 22, wherein capturing three or more 2-D image layers comprises capturing multiple 2-D images using a single user image capturing input.

24. The medium of claim 23, wherein the electronic device comprises a mobile electronic device.
